(19) United States
(12) Patent Application Publication
(10) Pub. No.: US 2024/0255387 A1
(43) Pub. Date: Aug. 1, 2024

(54) SOUND DIAGNOSIS SYSTEM, SOUND DIAGNOSIS METHOD, AND SOUND DIAGNOSIS PROGRAM

(71) Applicant: Konica Minolta, Inc., Tokyo (JP)

(72) Inventor: KENJI ONO, Toyokawa-shi (JP)

(21) Appl. No.: 18/404,367

(22) Filed: Jan. 4, 2024

(30) Foreign Application Priority Data
Jan. 26, 2023 (JP) 2023-010334

(51) Int. Cl. G01M 99/00

(52) U.S. Cl. CPC G01M 99/005

(57) ABSTRACT

A sound diagnosis system includes: a sound collector acquiring a sound emitted by a device; a total sound pressure calculator that analyzes a sampling result of the sound and calculates a total sound pressure of a sound of each frequency included in each timing of the sampling result; a peak detector that detects a plurality of peak timings from the total sound pressure; a peak classifier that clusters the plurality of peak timings; a cycle calculator that calculates a cycle of a sound included in each cluster based on the frequency and/or each total sound pressure; a region identifier that identifies at least one component that emits a sound having a cycle close to any of cycles of sounds included in each cluster; and a display that displays the at least one identified component.

The entire disclosure of Japanese patent Application No. 2023-010334, filed on Jan. 26, 2023, is incorporated herein by reference in its entirety.

### BACKGROUND

### Technological Field

The present disclosure relates to a sound diagnosis system, and more specifically, to a sound diagnosis system using sound pressure.

### Description of the Related Art

In a case where a device such as a home appliance used at home or an image forming device used in an office fails, the device may emit abnormal noise. A service engineer may identify a failed component on the basis of the abnormal noise and replace the failed component. However, in a case where a device including a plurality of motors or the like fails, the service engineer may not be able to identify which component of the device is emitting the abnormal noise. In this case, the service engineer cannot specify which component should be repaired or replaced. Therefore, there is a need for a sound diagnosis technique for easily identifying a component that makes abnormal noise in a device.

Regarding sound diagnosis, for example, JP 2020-071436 A discloses “a source identification device and an image forming device capable of identifying a source of abnormal noise”. The device “comprises memory and a processor. The memory stores information on drive frequencies of drive mechanisms. The processor detects abnormal noise from among noises of the drive mechanisms, identifies an occurrence interval of the detected abnormal noise, and identifies a drive mechanism generating the abnormal noise on the basis of the identified occurrence interval of the abnormal noise and the information stored in the memory” (see Abstract).

In addition, other techniques related to sound diagnosis are disclosed in, for example, JP 2017-138151 A and JP 2006-145404 A.

A device subjected to sound diagnosis may be used in a noisy environment. In addition, the device subjected to sound diagnosis may include a plurality of components that emit driving sound. These components include different frequency components. Under such an environment, the device for sound diagnosis picks up a plurality of sounds including different frequency components. In the techniques disclosed in JP 2020-071436 A, JP 2017-138151 A, and JP 2006-145404 A, when the sound diagnosis device picks up sounds of a plurality of sound sources in this manner, it is not possible to specify the source of the abnormal noise. Therefore, there is a need for a technique capable of specifying a source of abnormal noise even in an environment where a sound diagnosis device picks up sounds of a plurality of sound sources.

### SUMMARY

The present disclosure has been made in view of the above background, and an object in one aspect is to provide a technique for specifying a source of abnormal noise even in an environment where a sound diagnosis device picks up sounds of a plurality of sound sources.

To achieve the abovementioned object, according to an aspect of the present invention, sound diagnosis system reflecting one aspect of the present invention comprises: a sound collector acquiring a sound emitted by a device: a total sound pressure calculator that analyzes a sampling result of the sound and calculates a total sound pressure of a sound of each frequency included in each timing of the sampling result: a peak detector that detects a plurality of peak timings from the total sound pressure: a peak classifier that clusters the plurality of peak timings: a cycle calculator that calculates a cycle of a sound included in each cluster based on the frequency and/or each total sound pressure: a region identifier that identifies at least one component that emits a sound having a cycle close to any of cycles of sounds included in each cluster; and a display that displays the at least one identified component.

### BRIEF DESCRIPTION OF THE DRAWINGS

The above and other objects, advantages, aspects, and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of a configuration of a sound diagnosis system to which the technique of the present disclosure can be applied;

FIG. 2 is a diagram illustrating an example of a configuration included in the sound diagnosis system according to the present embodiment:

FIG. 3 is a diagram illustrating an example of a procedure of diagnosis processing executed by the sound diagnosis system:

FIG. 4 is a diagram illustrating an example of a spectrogram:

FIG. 5 is a diagram illustrating an example of analysis processing of an acquired spectrogram:

FIG. 6 is a diagram illustrating an example of data of the sum of sound pressures of respective frequencies for each time:

FIG. 7 is a diagram illustrating an example of peak value information:

FIG. 8 is a diagram conceptually illustrating a certain spectrogram:

FIG. 9 is a diagram illustrating an example of a prominence of a peak of total sound pressure:

FIG. 10 is a diagram illustrating an example of a procedure of clustering (classification) by a peak classifier 208:

FIG. 11 is a diagram illustrating an example of a clustering result of peak timings:

FIG. 12 is a diagram illustrating an example of a first window displayed on a display:

FIG. 13 is a diagram illustrating an example of a second window displayed on the display:

FIG. 14 is a diagram illustrating the rest of the second window displayed on the display:

FIG. 15 is a diagram illustrating an example of a cycle table:

FIG. 16 is a diagram illustrating a first example of a set of clustered peak timings:

FIG. 17 is a diagram illustrating an example of a calculation result of an occurrence cycle of the clustered peak timings:

FIG. 18 is a diagram illustrating a second example of a set of clustered peak timings; and

FIG. 19 is a diagram illustrating an example of a calculation result of an occurrence cycle of clustered peak timings.

### DETAILED DESCRIPTION OF EMBODIMENTS

Hereinafter, one or more embodiments of the technical idea according to the present invention will be described with reference to the drawings. However, the scope of the invention is not limited to the disclosed embodiments. In the following description, the same components are denoted by the same reference numerals. Their names and functions are the same. Therefore, detailed descriptions thereof will not be repeated.

### A. APPLICATION EXAMPLES

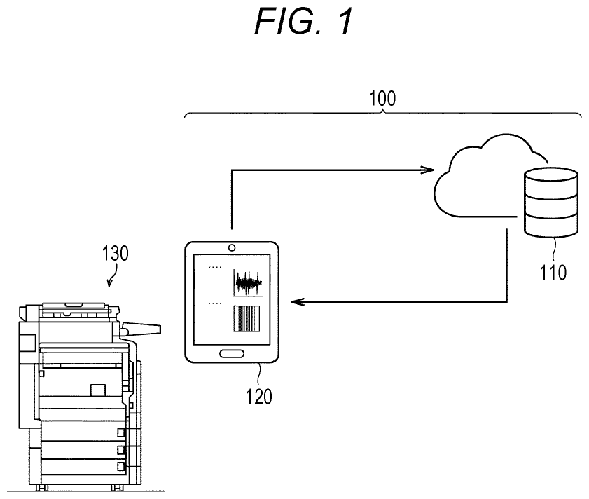

FIG. 1 is a diagram illustrating an example of a configuration of a sound diagnosis system 100 to which the technique of the present disclosure can be applied. With reference to FIG. 1, an outline of the sound diagnosis system 100 to which the technique of the present disclosure can be applied, and problems in sound diagnosis will be described. In addition, terms used in the present specification will be described.

### a. Configuration of System to which Technique of the Present Disclosure is Applicable

As an example, the sound diagnosis system 100 includes a diagnosis device 120 and a server 110. According to an embodiment, the diagnosis device 120 may have the function of the server 110. The device 130 is a target of sound diagnosis. The device 130 is any device comprising a drive component. The device 130 includes office equipment such as an image forming device, home appliances, equipment in a factory, research equipment, and the like.

The diagnosis device 120 collects a sound emitted by the device 130 and displays an analysis result. The service person carries the diagnosis device 120 in order to perform maintenance management, repair, and the like of a maintenance target device used by end users. The diagnosis device 120 acquires abnormal noise generated by a device to be maintained. The diagnosis device 120 acquires at least abnormal noise generated by a device to be maintained, and displays an analysis result of the acquired abnormal noise. The abnormal noise analysis result includes waveform data and/or a candidate of a component inferred to emit the abnormal noise.

According to an embodiment, the diagnosis device 120 transmits the sampled sound data to the server 110. Then, the diagnosis device 120 receives the analysis result from the server 110. Further, the diagnosis device 120 displays the analysis result on a screen. The analysis result includes at least information on a candidate of a component emitting the abnormal noise. The diagnosis device 120 and the server 110 are connected via a wireless or wired network so as to be able to transmit and receive data to and from each other.

According to another embodiment, the diagnosis device 120 analyzes sampled sound data. Then, the diagnosis device 120 displays the analysis result on the screen. The analysis result includes at least information on a candidate of a component emitting the abnormal noise. In this case, the sound diagnosis system 100 may not include the server 110.

According to another embodiment, the diagnosis device 120 is a tablet, a smartphone, a personal computer, smart glasses, or any other information processing device. The diagnosis device 120 may be equipped with a normal microphone, a directional microphone, or the like. In addition, the diagnosis device may be connectable to a normal microphone or a directional microphone.

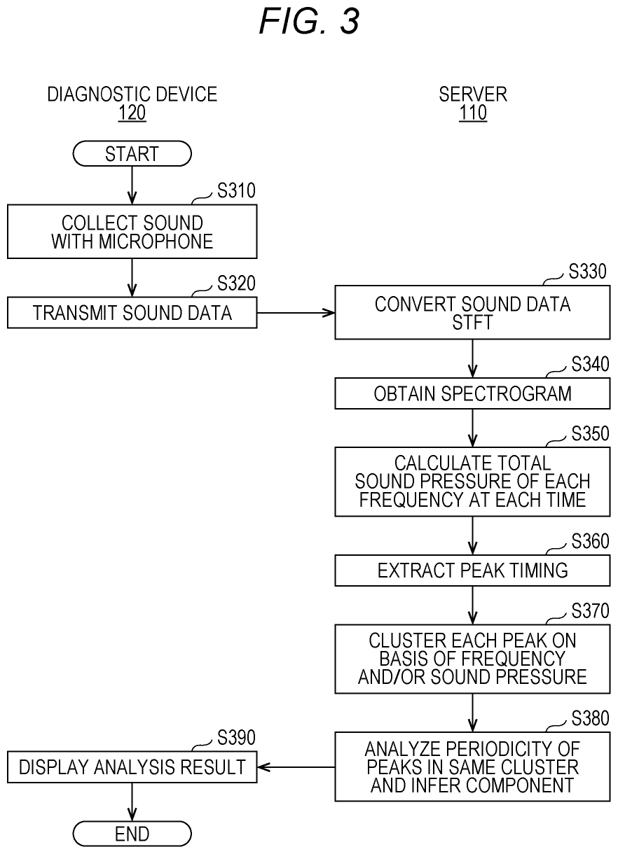

The server 110 receives sound data from the diagnosis device 120 via the network. The server 110 analyzes the sound data and returns the analysis result to the diagnosis device 120. The analysis result includes waveform data and/or a candidate of a component inferred to emit the abnormal noise. Details of the sound data analysis procedure will be described later with reference to FIGS. 3 to 11. According to an embodiment, the server 110 may be implemented as at least one device, a virtual machine built on a cloud environment, or a combination thereof.

The device 130 is a device to be diagnosed. The device 130 comprises at least one drive component. The drive component is a component driven by a motor. The sounds emitted by the drive components may have different frequencies. The diagnosis device 120 uses the frequency of the sound emitted by each drive component to identify the source of each sound. According to an embodiment, the device 130 is an image forming device including a plurality of drive sources. In this case, the drive source drives at least one of a fuser belt, a paper delivery roller, a paper feeding roller, and a fuser gear.

### b. Problems that May Occur in Sound Diagnosis

As previously mentioned, the device 130 comprises at least one drive component. For example, an image forming device used in an office or the like includes a large number of drive components. Therefore, even if the diagnosis device 120 collects the abnormal noise, it is not easy to specify which drive component is emitting the abnormal noise. In order to solve this problem, the sound diagnosis system 100 has a function of picking up a plurality of sounds emitted by the device 130 and classifying each sound. In addition, the sound diagnosis system 100 has a function of specifying a component that emits each sound from each classified sound.

### c. Terminology Used Herein

Next, terms used to describe the technique of the present disclosure will be described.

The “system” in the present specification includes a configuration including one or a plurality of devices and a server. The system also includes a virtual machine or a container constructed in a cloud environment, or a configuration including at least a part thereof.

The “device” herein may be any information processing device such as a personal computer, a workstation, a server device, a tablet, or a smartphone. In addition, the device may be a combination thereof.

According to an embodiment, the sound diagnosis system 100 may be connected to input/output devices such as a screen and a keyboard and used by a user. According to another embodiment, the sound diagnosis system 100 may provide various functions to the user as a service or a web application via a network. In this case, the user can use the function of the sound diagnosis system 100 via a browser or client software installed in his/her terminal.

The “device to be diagnosed” in the present specification includes a device installed in an arbitrary place such as a home, an office, a factory, a school, or a laboratory. As an example, the device to be diagnosed is any device such as a refrigerator, an air conditioner, an image forming device, a manufacturing device disposed in a factory, or a robot. The device to be diagnosed includes at least one drive component. In the present specification, a device to be diagnosed may be simply referred to as a device.

The “component (drive component)” in the present specification is a component included in a device to be diagnosed. The component may be a motor or a combination of a motor and a power transmission component. In addition, the component may be a combination of a motor, a power transmission component, and a subsequent component. Alternatively, the component and the drive component may be components driven by a motor.

The “sound and sound data” in the present specification is a sound emitted by a device to be diagnosed. In addition, the sound and sound data may be data picked up by the diagnosis device 120 with the microphone, that is, sampled sound data. The sampled sound data is digital data represented by an arbitrary resolution.

The “sound pressure” in the present specification is a variation from the atmospheric pressure due to sound. The sound pressure is defined as the effective value of the maximum amplitude.

The “total sound pressure (total sound intensity)” in the present specification is a sum or an average value of the sound pressures of the respective frequency components at a certain timing of the spectrogram. The spectrogram includes a plurality of frequency components for each timing. For example, it is assumed that frequency components X, Y, and Z are included in the timing A of the spectrogram. In this case, the total sound pressure (total sound intensity) at the timing A is calculated by the formula: Total sound pressure at timing A=sound pressure of frequency component X+sound pressure of frequency component Y+sound pressure of frequency component Z. Alternatively, the total sound pressure (total sound intensity) at the timing A may be an average value of the sound pressures of the frequency components X, Y, and Z.

The “peak timing (of the total sound pressure)” in the present specification is a timing at which the sound pressure is higher by a certain level or more than the sound pressure at the preceding and subsequent timings in the continuous graph of the total sound pressure. The peak timing may be simply referred to as a peak. In addition, a sound (total sound pressure) at a certain peak timing may be referred to as a peak.

### B. DEVICE CONFIGURATION

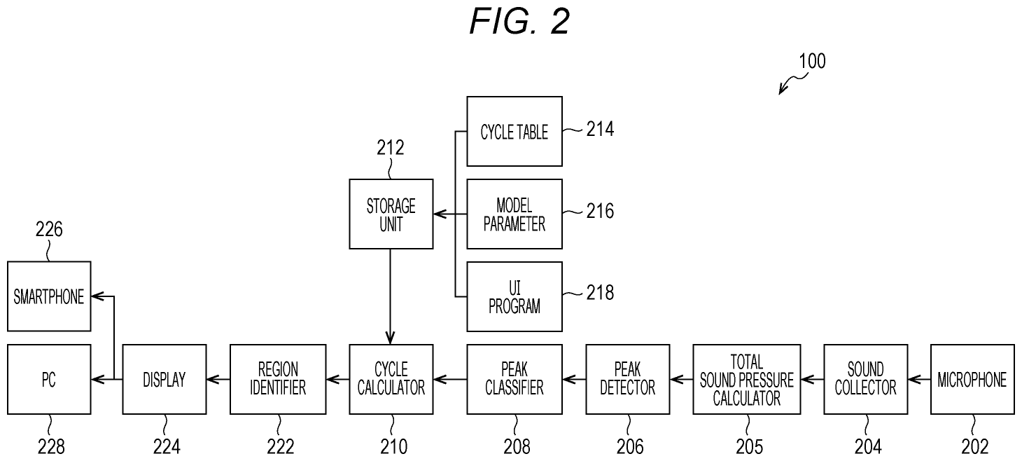

FIG. 2 is a diagram illustrating an example of a configuration included in the sound diagnosis system 100 according to the present embodiment. Some or all of the configurations illustrated in FIG. 2 may be realized as hardware. In addition, some configurations illustrated in FIG. 2 may be realized as software. In this case, the sound diagnosis system 100 includes a processor (not illustrated) for executing each software, a memory (not illustrated), and a storage (not illustrated).

The sound diagnosis system 100 includes a microphone 202, a sound collector 204, a total sound pressure calculator 205, a peak detector 206, a peak classifier 208, and a cycle calculator 210. Furthermore, the sound diagnosis system 100 includes a storage 212, a region identifier 222, and a display 224. The storage 212 stores a cycle table 214, a model parameter 216, and a user interface (UI) program 218.

According to an embodiment, the diagnosis device 120 includes a microphone 202, a sound collector 204, and a display 224. The server 110 includes the total sound pressure calculator 205, the peak detector 206, the peak classifier 208, the cycle calculator 210, the storage 212, and the region identifier 222.

According to another embodiment, the diagnosis device 120 may include a function of the server 110 in addition to the microphone 202, the sound collector 204, and the display 224. In this case, the diagnosis device 120 includes the total sound pressure calculator 205, the peak detector 206, the peak classifier 208, the cycle calculator 210, the storage 212, and the region identifier 222.

The microphone 202 converts sound into an electric signal and outputs the electric signal to the sound collector 204. The device 130 may comprise a plurality of sound sources (drive components). In this case, the microphone 202 picks up a synthesized sound emitted by the plurality of sound sources.

The sound collector 204 converts the electrical signal output from the microphone 202 into a digital signal to generate sound data (sampling result). The sound collector 204 converts an analog signal into sound data that is a digital signal in arbitrary resolution. The sound collector 204 outputs the generated sound data (sampling result) to the peak detector 206.

The total sound pressure calculator 205 calculates a total sound pressure of a sound of each frequency included in each timing of the sampling result. More specifically, the total sound pressure calculator 205 calculates the sum or the average value of the sound pressures of the respective frequencies at each timing of the sampling result. The total sound pressure calculator 205 performs short-time Fourier transform (STFT) on the sound data. The total sound pressure calculator 205 performs STFT on the sound data to obtain a frequency spectrum waveform (spectrogram). The total sound pressure calculator 205 calculates the sum of the values of the respective frequencies at each timing in order to obtain the sound pressure at a certain timing from the spectrogram. Alternatively, the total sound pressure calculator 205 calculates the average value of the respective frequencies at each timing in order to obtain the sound pressure at a certain timing from the spectrogram.

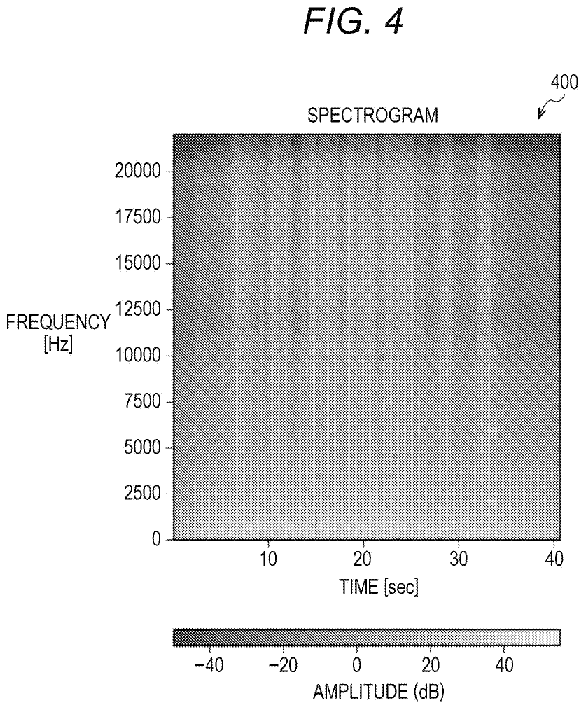

The peak detector 206 determines the peak timing of the sound pressure. More specifically, the peak detector 206 extracts, as the peak timing, a timing at which the difference between the sound pressure at each timing and the adjacent sound pressure is a preset value or greater. Alternatively, the peak detector 206 may extract the peak timing on the basis of the prominence value (degree of protrusion) of the sound pressure. Details of the peak detector 206 will be described later with reference to FIGS. 4 to 9. According to an embodiment, the peak detector 206 may also have the function of the total sound pressure calculator 205.

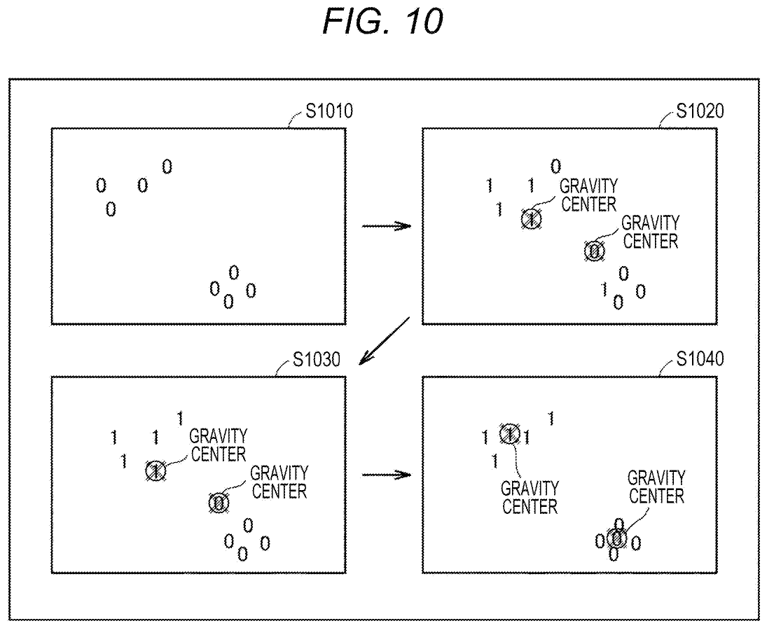

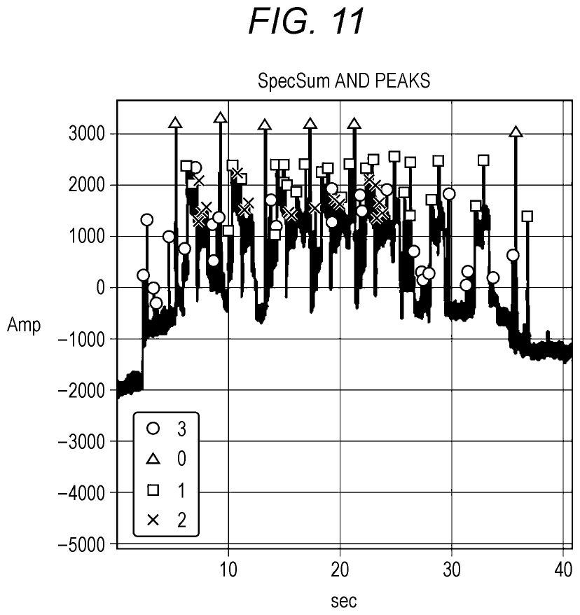

The peak classifier 208 classifies the extracted peak timing into a predetermined number of patterns (the number of clusters). In order to classify each peak timing, the peak classifier 208 uses the frequency and the peak prominence value of the peak timing as the feature amount. The peak classifier 208 may classify the sound pressure at each peak timing on the basis of machine learning. As an example, the peak classifier 208 uses k-means clustering of unsupervised learning. Details of the classification of the sound pressure at each peak timing will be described later with reference to FIGS. 10 and 11.

The cycle calculator 210 calculates an interval between peak timings for each category (cluster) of the classified sound pressure at the peak timings. As an example, the cycle calculator 210 calculates the cycle by obtaining the mode value of the interval between the peak timings. The interval between the peak timings is an interval between the generation timings of the respective peak sounds. As another example, the cycle calculator 210 calculates the cycle by using an average value or a median value for the calculation of the cycle.

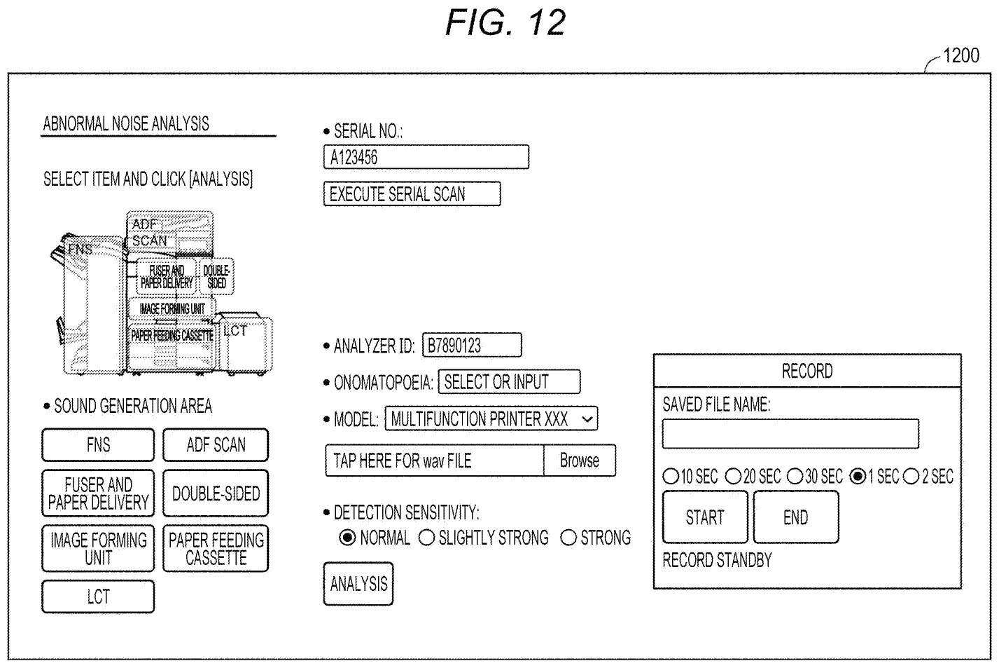

The region identifier 222 collates each cycle calculated in each cluster with the cycle table 214. The region identifier 222 specifies a failed component by searching for a component that emits a sound having a cycle close to that of the sound of each cluster by collation. Details of the processing of the region identifier 222 will be described later with reference to FIGS. 12 to 14.

The storage 212 stores data necessary for performing each processing of the flow of FIG. 3 and UI data provided to the user. The cycle table 214 includes cycle data of sounds emitted by the drive components. In addition, the cycle table 214 may include cycle data of clustered sound data. The model parameters 216 include parameters of a machine learning model used for clustering. The UI program 218 is UI data or a program provided to the user. The UI program 218 includes UI design data, an event program associated with each UI component, and the like.

The display 224 displays the analysis result of the sound data and the candidate of the component emitting the abnormal noise. As an example, the display 224 displays the windows illustrated in FIGS. 12 to 14 on the screen of the diagnosis device 120. Alternatively, the display 224 may transmit the display data to another smartphone 226, a personal computer (PC) 228, or another arbitrary device.

### C. PROCEDURE OF SOUND DIAGNOSIS

FIG. 3 is a diagram illustrating an example of a procedure of diagnosis processing executed by the sound diagnosis system 100. An outline of diagnosis processing of the sound diagnosis system 100 will be described with reference to FIG. 3. Details of each processing in FIG. 3 will be described later with reference to FIGS. 4 to 19. According to an embodiment, the processor of the sound diagnosis system 100 may read a program for performing the processing of FIG. 3 from the storage into the memory and execute the program. In another aspect, a part or all of the processing can be realized as a combination of circuit elements executing the processing.

In step S310, the diagnosis device 120 picks up the sound of the device 130 to be diagnosed with the microphone (microphone 202). More specifically, the microphone 202 of the diagnosis device 120 picks up the sound emitted by the device 130. In addition, the sound collector 204 converts the sound (analog signal) into sampled sound data (digital data).

In step S320, the diagnosis device 120 transmits the sound data to the server 110. In an embodiment, in a case where the diagnosis device 120 also has the function of the server 110, the sound diagnosis system 100 may not execute the processing of step S320.

In step S330, the server 110 executes STFT on the acquired sound data. In step S340, the server 110 acquires a spectrogram as a result of STFT. As an example, the server 110 obtains a spectrogram 400 as illustrated in FIG. 4.

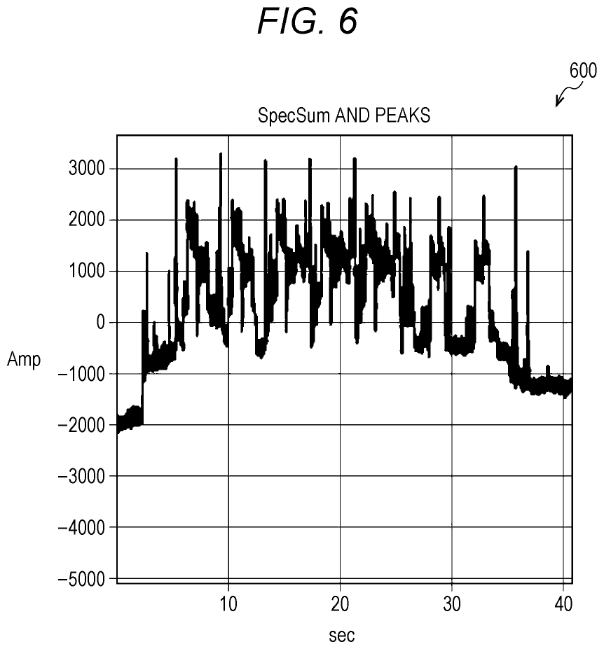

In step S350, the server 110 calculates the sum (total sound pressure) of the sound pressures of the respective frequencies at every certain time (timing) in the spectrogram. Alternatively, the server 110 calculates an average value of the sound pressures of the respective frequencies at every certain time (timing) in the spectrogram. As an example, the server 110 obtains data 600 as illustrated in FIG. 6. The data 600 includes information indicating a sum or an average value of sound pressures of respective frequencies at every certain time (timing) in the spectrogram 400.

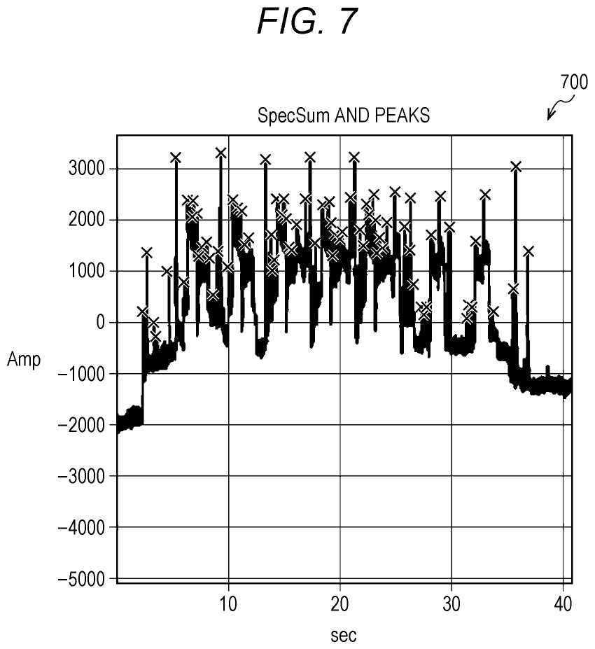

In step S360, the server 110 extracts the peak timing of the total sound pressure from the data 600. The peak timing is a timing at which the total sound pressure is larger than the preceding and subsequent timings by a certain amount or more in the graph of the total sound pressure. In other words, it is a portion that is greatly convex in the graph of the total sound pressure. As an example, the server 110 acquires the peak value information 700 of the peak timing as illustrated in FIG. 7.

In step S370, the server 110 clusters each peak timing on the basis of the frequency and/or the sound pressure of each peak timing included in the peak value information 700.

In step S380, the server 110 analyzes periodicity of peak timings in the same cluster, and infers a component that emits a sound close to the sound classified into the cluster. The server 110 can calculate the periodicity of the peak timing from the occurrence timing of each peak timing. For example, the server 110 compares sound data (sound pressure, cycle, etc.) for each component stored in advance in the storage 212 with an analysis result of each cluster. As a result, the server 110 can infer components that are sound generation sources classified into each cluster. The server 110 transmits the analysis result to the diagnosis device 120.

In step S390, the diagnosis device 120 displays the received diagnostic result on the screen (not illustrated). According to an embodiment, the diagnosis device 120 may transfer the analysis result to another device (such as a PC or a smartphone).

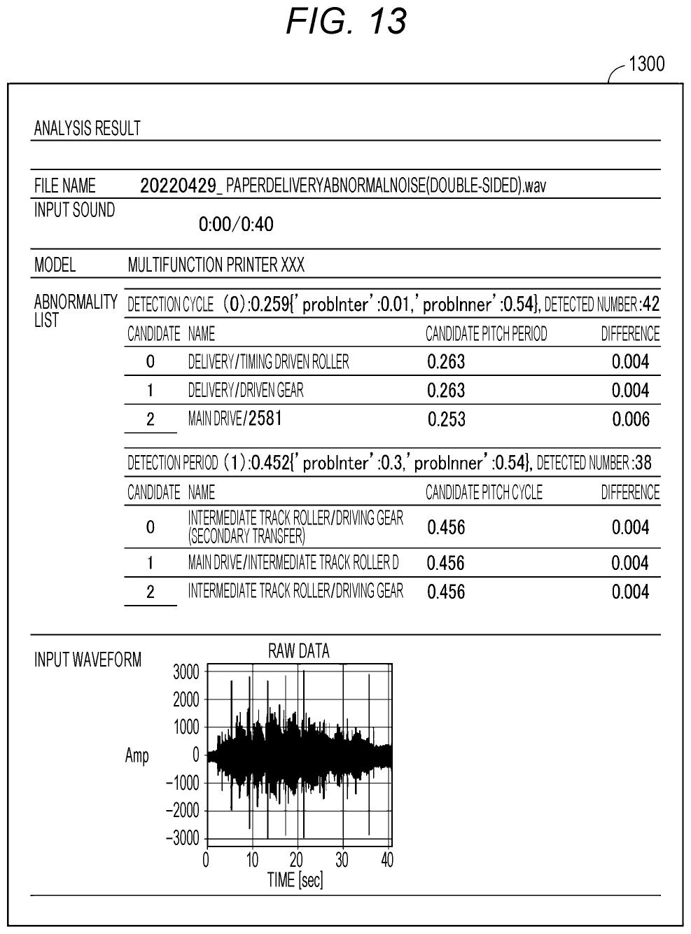

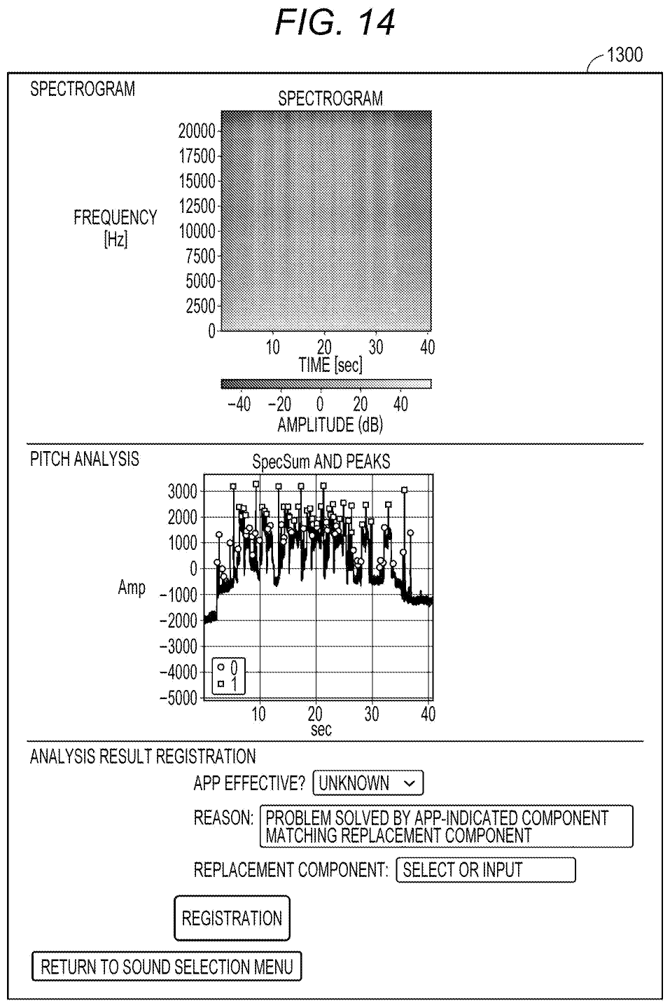

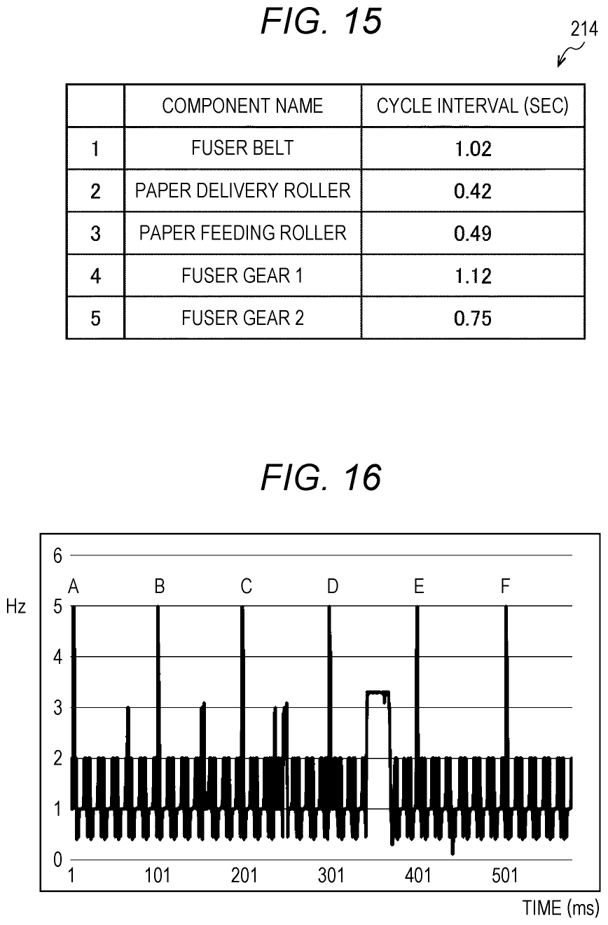

That is, the sound diagnosis system 100 acquires the sound emitted by the device 130 by the sound collector 204. At that time, the sound collector 204 can convert an analog signal of the sound into a digital signal (sampling result). The sound diagnosis system 100 analyzes a sampling result of the sound and calculates a total sound pressure of a sound of each frequency included in each timing of the sampling result by the cycle calculator 210 (see FIG. 4). In the sound diagnosis system 100, the peak detector 206 extracts a plurality of peak timings from the total sound pressure (see FIG. 7). In the sound diagnosis system 100, the peak classifier 208 clusters a plurality of peak timings (see FIG. 11). The sound diagnosis system 100 calculates a cycle of a sound included in each cluster on the basis of the frequency and/or each total sound pressure by the cycle calculator 210 (see FIG. 11). The sound diagnosis system 100 identifies at least one component that emits a sound having a cycle close to any of cycles of sounds included in each cluster by the region identifier 222 (region identifier) (see FIGS. 15 to 17). The sound diagnosis system 100 displays the at least one identified component by the display 224 (FIGS. 13 and 14).

### D. DETAILS OF EACH PROCEDURE

Next, details of each processing of the flow of FIG. 3 will be described with reference to FIGS. 4 to 19. More specifically, the processing of steps S330 to S390 will be described in detail with reference to FIGS. 4 to 19.

FIG. 4 is a diagram illustrating an example of the spectrogram 400. The spectrogram 400 shows an example of data acquired in steps S330 and S340. The sound diagnosis system 100 performs STFT on the sound data of the device 130 to acquire the spectrogram 400. The sound data includes a plurality of frequency components. That is, the sound data is a set of a plurality of sounds having different frequencies. Hereinafter, the “frequency or frequency component” may indicate sound of a certain frequency or sound data of a certain frequency. The spectrogram 400 indicates a temporal change in the sound pressure distribution of each frequency component. In other words, the spectrogram 400 contains information of various sounds emitted by each component of the device 130.

As described below, the sound diagnosis system 100 calculates the sum or the average value of the sound pressures of the respective frequencies from the spectrogram 400. As a result, the sound diagnosis system 100 calculates the total sound pressure (sum or average value) of the sound of each frequency included in each timing of the sampling result.

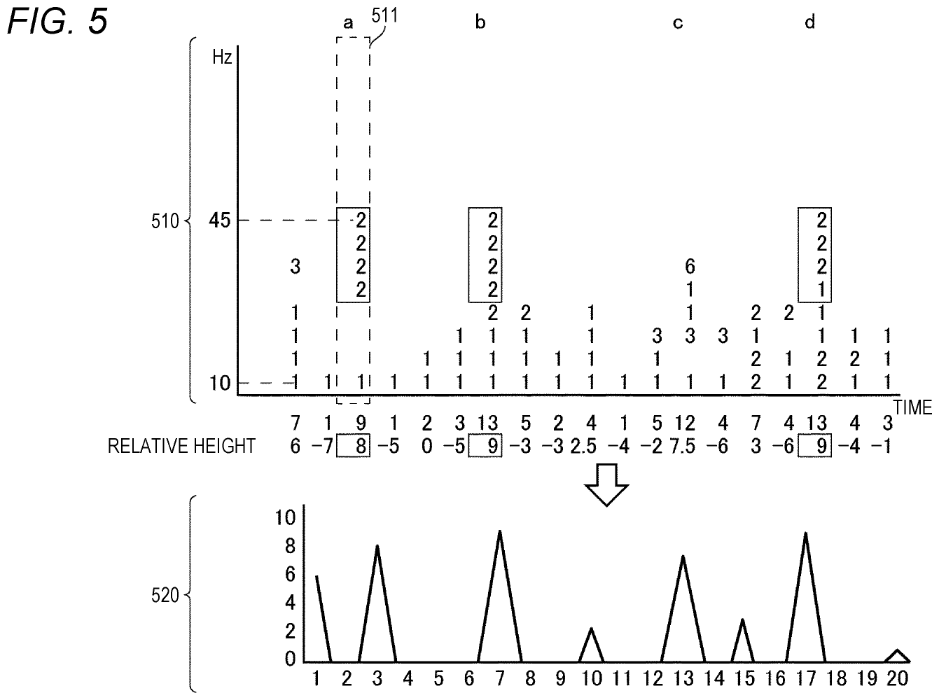

FIG. 5 is a diagram illustrating an example of analysis processing of an acquired spectrogram. The processing of FIG. 5 corresponds to the processing of step S350. The conceptual diagram 510 conceptualizes the spectrogram 400. In the conceptual diagram 510, the vertical axis represents the frequency. The horizontal axis in the conceptual diagram 510 indicates time. The number in the graph indicates the sound pressure for each frequency at a certain timing. When the conceptual diagram 510 is taken as an example, the sound pressure at the frequency of 45 Hz at a timing a is 2. Similarly, the sound pressure at a frequency of 10 Hz at the timing a is 1.

Here, attention is given to the timing a. A column 511 of the timing a shows 1, blank, blank, 2, 2, 2, 2 from the bottom. This indicates that, at the timing a, the sound pressure of 10 Hz is 1, the sounds of 15, 20, and 25 Hz are not generated, and the sound pressures of 30, 35, 40, and 45 Hz are 2.

The server 110 calculates the total sound pressure at the timing a. Specifically, the server 110 adds up the sound pressures of the respective frequency components at the timing a. As described above, the total sound pressure (total sound intensity) in the present specification is a sum or an average value of the sound pressures of the respective frequency components at a certain timing of the spectrogram. Referring to the conceptual diagram 510, the server 110 calculates “1+2+2+2+2=9” to obtain the total sound pressure “9” at the timing a. According to an embodiment, the server 110 may calculate the average value of the sound pressures at the timing a. Similarly, the server 110 calculates the total sound pressure at each timing (timings b, c, d, etc.). The server 110 acquires the data 600 by performing such calculation.

According to an embodiment, the server 110 may multiply by a coefficient the sound pressures of frequency components (for example, 1000 Hz or more) that are frequently generated. The server 110 can calculate the occurrence frequency for each frequency from the sound data acquired in the past. That is, the server 110 (the total sound pressure calculator 205) can adjust the addition value of the sounds of the respective frequencies in accordance with the sound generation frequency of the respective frequencies.

According to another embodiment, the server 110 may add up sound pressures for each frequency at a certain timing except for frequencies generated from components other than the component to be maintained. For example, when a frequency component of 500 Hz or less is not generated from the component to be maintained, the frequency component of 500 Hz or less is considered to be mere noise. Therefore, the server 110 adds up the sound pressures for respective frequencies at a certain timing except for the frequency component of 500 Hz or less. As described above, the server 110 obtains the sound pressure from the spectrogram instead of the amplitude. As a result, the server 110 can execute processing in consideration of the importance of the frequency band (weighting based on the frequency of occurrence of the frequency component). In addition, since the peak of the sound pressure is likely to appear more clearly than the peak of the amplitude, the server 110 can more easily perform the peak timing detection processing.

A graph 520 illustrates a relative value of the total sound pressure (relative total sound pressure) for each timing. For example, the sound intensity at the timing a is 9. The intensity of the sound at the timing a is higher by 8 on average than the intensities of the sounds at the preceding and subsequent timings. Therefore, the value on the vertical axis at the timing a in the graph 520 is 8.

FIG. 6 is a diagram illustrating an example of data 600 of the sum of the sound pressures of the respective frequencies for each time. The data 600 indicates an example of data obtained by executing the processing of step S350. As described above, the server 110 obtains the sound pressure at each frequency for each timing of the spectrogram 400. Then, the server 110 calculates the total value (total sound pressure) of the sound pressures of the respective frequencies at each timing of the spectrogram 400. Thus, the server 110 obtains the data 600. The data 600 indicates a continuous value of the total sound pressure.

FIG. 7 is a diagram illustrating an example of peak value information 700. The peak value information 700 indicates an example of data obtained by executing the processing of step S350. The server 110 (peak detector 206) compares the total sound pressure at a certain timing with the total sound pressure at an adjacent timing. It is assumed that the total sound pressure at a certain timing is higher than the total sound pressure at an adjacent timing by a predetermined threshold or more. In this case, the server 110 (peak detector 206) determines the certain timing as the peak timing. The server 110 (peak detector 206) acquires the intensity of the sound at that time as a peak value. The sign “x” in the peak value information 700 indicates the peak value. Hereinafter, the value of the peak timing may be referred to as a “peak value or peak sound pressure”.

A method of obtaining the peak timing will be described in more detail with reference to a conceptual diagram 510 as an example. The intensity of the sound at the timing a is 9. The intensity of the sound at the timing immediately before the timing a is 1. The intensity of the sound at the timing immediately after the timing a is 1. The server 110 (peak detector 206) obtains a difference between the intensity of the sound at the timing a and the intensity of the sound before and after the timing a. The difference is “9−1=8”, which is a relative value with respect to the timing before and after the timing a.

Assume that the predetermined threshold is 0. In this case, the sound intensity “9” at the timing a exceeds a predetermined threshold value “0”. Therefore, the server 110 (peak detector 206) determines that the timing a is the peak timing. Then, the server 110 (peak detector 206) determines that the intensity of the sound at the timing a is the peak value or the peak sound pressure. Note that, from the above description, it can also be said that the graph 520 indicates the intensity of the sound selected as the peak. The sound diagnosis system 100 calculates the total sound pressure at a certain timing among the timings by calculation. In addition, the sound diagnosis system 100 calculates the total sound pressure at timing before and after certain timing. Then, the sound diagnosis system 100 compares a difference between the total sound pressure at a certain timing and the total sound pressure before and after the certain timing. The sound diagnosis system 100 determines whether or not a certain timing is a peak timing on the basis of the difference. In other words, the sound diagnosis system 100 extracts a certain timing as the peak timing on the basis of the difference being a predetermined threshold or greater (a certain value or greater).

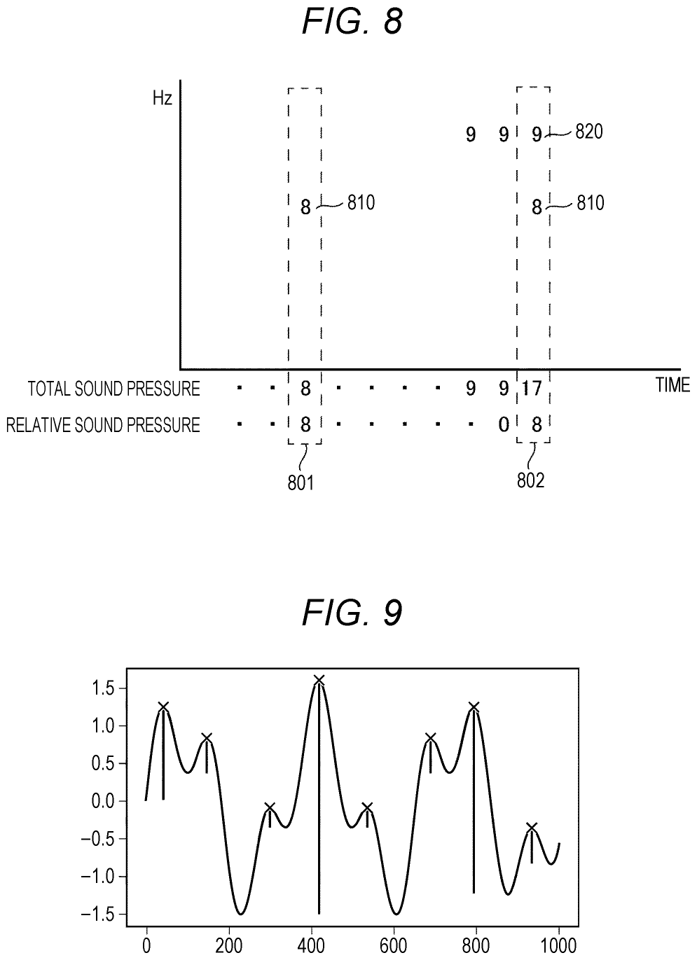

FIG. 8 is a diagram conceptually illustrating a certain spectrogram. The reason why the relative sound pressure (relative sound intensity) is calculated as illustrated in FIG. 7 in order to detect the peak timing will be described with reference to FIG. 8.

For example, it is assumed that a certain component of the device 130 fails and emits abnormal noise. In this case, the failed component periodically emits momentary abnormal noise. On the other hand, the failed component also emits a normal driving sound. Therefore, the failed component may emit only abnormal noise at a certain timing and emit both abnormal noise and a normal sound at another timing.

The failed component emits only abnormal noise 810 (sound pressure 8) at certain timing 801. On the other hand, the failed component emits abnormal noise 810 (sound pressure: 8) and a normal sound 820 (sound pressure: 9) at another timing 802. In such a case, it is assumed that the server 110 obtains the total sound pressure at the timings 801, 802 as described with reference to FIGS. 5 and 6. In this case, the total sound pressure at the timing 801 is “8”. The total sound pressure at the timing 802 is “17 (8+9)”.

At all timings 801, 802, abnormal noise is generated. Therefore, it is desirable that the server 110 similarly classifies the sound at the timings 801, 802 into the same cluster in clustering (described later). However, the timings 801, 802 are greatly different from each other in the total sound pressure. Therefore, there is a possibility that the server 110 cannot classify the sounds at the timings 801, 802 into the same cluster.

Therefore, the server 110 leverages a characteristic that the component emits a normal sound for a certain long period of time. For example, it is assumed that a failed component emits abnormal noise and a normal sound at a certain timing. In this case, there is a high possibility that the failed component emits only a normal sound before and after that. In the example of FIG. 8, the normal sound 820 is continuously generated. The server 110 compares the total sound pressure at the timing when the abnormal noise and the normal sound are generated, with the sound pressures before and after the generation of the abnormal noise and the normal sound (the total sound pressure at the timing when only the normal sound is generated). Thus, the server 110 can extract only the abnormal noise from the combination of the abnormal noise and the normal sound. That is, the server 110 can extract only the abnormal noise component by comparing the total sound pressure at a certain timing with the total sound pressure before and after the timing.

FIG. 9 is a diagram illustrating an example of the prominence of the peak of the total sound pressure. The server 110 may detect the peak timing of the total sound pressure on the basis of the prominence value (degree of protrusion) of the peak. Prominence is a method of calculating the degree of protrusion of each peak according to the relative position between a certain peak and another peak.

A specific method of calculating the prominence is as follows. First, attention is given to a certain peak (peak timing). Next, the horizontal line of the peak is extended to the left and right until the horizontal line of the peak intersects a higher peak or reaches left and right ends (graph ends) of the signal. Next, the signal with the minimum value is found on the right side and the left side of the section in which the horizontal line is extended. Next, the larger one of the minimum value in the right section and the minimum value in the left section is set as the reference value. Next, a peak larger than the reference level is set as the prominence value.

The calculation using the prominence is measured by the degree of protrusion from the surroundings (the height of the peak relative to the surroundings) even at the peak timing having a larger value including an ambient sound. Therefore, in the calculation using the prominence, the peak can be detected using a value similar to the peak timing not including the ambient sound. Therefore, in the clustering (described later), peaks having the same prominence value are easily classified into the same category.

According to an embodiment, the server 110 may not perform the peak detection for a certain period of time after the peak is detected in any procedure of FIGS. 6 and 7. As a result, the server 110 can respond to a case where a peak occurs during a very short time due to noise.

FIG. 10 is a diagram illustrating an example of a procedure of clustering (classification) by the peak classifier 208. The peak classifier 208 classifies the extracted peaks into a predetermined number of clusters (groups). For example, when the predetermined number of clusters is four, the peak classifier 208 classifies the extracted peaks into four clusters. The peak classifier 208 uses the frequency and the peak prominence value of the peak timing as the feature amount at the time of classifying each peak.

It has been experimentally found that the peak prominence value of the target component is hardly affected by the surrounding environment. Therefore, the classification using both the frequency and the peak prominence value as the feature amount has higher accuracy than the classification using only the frequency as the feature amount. In the classification using both the frequency and the peak prominence value as the feature amount, peak points having close peak prominence values are likely to be classified into the same cluster even if the frequencies are different.

The peak classifier 208 may perform classification processing using machine learning. In this case, the peak classifier 208 allocates each of the plurality of peak timings to one of the clusters by clustering using machine learning. In the example of FIG. 10, the peak classifier 208 uses k-means clustering of unsupervised learning. According to an embodiment, the peak classifier 208 may use a non-hierarchical method or a hierarchical method other than k-means.

Description of k-means clustering will be given with reference to FIG. 10 as an example. In practice, the peak classifier 208 executes multidimensional clustering in which the frequency and the peak prominence value are combined. Here, in order to simplify the description, two-dimensional k-means clustering will be described. In the following example, the peak classifier 208 classifies eight pieces of data into two clusters.

In step S1010, the peak classifier 208 is given clustering data. The peak classifier 208 is given eight pieces of data (peak timings).

In step S1020, the peak classifier 208 randomly clusters the given data. The peak classifier 208 classifies the four data into cluster 0, and classifies the remaining four data into cluster 1. Next, the peak classifier 208 calculates the centroid of each cluster 0 or 1 from the point of each cluster.

In step S1030, the peak classifier 208 re-clusters each data. More specifically, the peak classifier 208 calculates the distance between each centroid and each point obtained in step 1020. Next, the peak classifier 208 re-classifies each point into a cluster of centroids having the shortest distance.

In step S1040, the peak classifier 208 calculates the centroid of the cluster again from each point. When the peak classifier 208 determines that the position of the centroid has converged, the processing is terminated. Otherwise, the peak classifier 208 clusters each point again until the position of the centroid converges.

According to an embodiment, the peak classifier 208 may receive the number of clusters (the number of groups) from a user. In this case, the peak classifier 208 classifies each point into the number of clusters designated by the user. According to another embodiment, the peak classifier 208 may automatically adjust the number of clusters by using a residual sum of squares (SSE) index in a cluster by the elbow method.

Furthermore, according to another embodiment, the peak classifier 208 may use, as a clustering method, a classification method using non-parametric estimation such as kmeans++ to which kmeans is applied and kernel density estimation.

According to another embodiment, the peak classifier 208 may use only the frequency at each peak timing as the feature amount. Furthermore, the peak classifier 208 may use only the relative height (relative sound pressure) or the prominence of the peak as the feature amount.

In addition, according to another embodiment, the peak classifier 208 may reclassify each point using a prominence as post-processing after the clustering is performed. For example, the peak classifier 208 may reclassify the points that are classified into different clusters but have similar prominence values into the same cluster.

FIG. 11 is a diagram illustrating an example of a clustering result of peak timings. In the example of FIG. 11, the peak classifier 208 obtains the optimum number of clusters by the elbow method, and clusters each peak timing by kmeans. FIG. 11 shows that each peak timing is classified into four clusters 0 to 3. In the above description, each peak timing is classified into each cluster. It can also be said that the sound causing each peak timing is classified into each cluster. Therefore, hereinafter, the classified data may be referred to as “peak timing for each cluster”, “peak for each cluster”, or “sound for each cluster”.

Next, processing of the cycle calculator 210 will be described. The cycle calculator 210 calculates an interval between peaks for each cluster of the classified peak timings. As an example, the cycle calculator 210 may calculate the cycle of each cluster by obtaining the mode value of the interval of the peak timings. As another example, the cycle calculator 210 may calculate the cycle of each cluster on the basis of an average value or a median value of intervals between peak timings. In other words, the cycle calculator 210 calculates a cycle for each of the clusters based on an interval between the adjacent peak timings in the same cluster. The cycle for each cluster indicates an occurrence cycle of each peak timing included in the cluster.

The actual cluster may include peak timing caused by noise or an unwanted sound. Therefore, the cycle calculator 210 may assume the distribution of the intervals between the peak timings in advance when calculating the cycle (statistical value) of each cluster. In this case, the cycle calculator 210 can regard a value at a certain distance or more from the interval between the peak timings assumed in advance as an outlier and exclude the outlier from the cycle calculation. In other words, the cycle calculator 210 can calculate a cycle except for the peak timing inferred to be erroneously detected or erroneously classified.

In some clusters, the variation in the interval between the peak timings may be a certain value or greater. In this case, the cycle calculator 210 can exclude the cluster from the extraction target on the basis of the fact that the peak timings do not occur at regular intervals. The reason why the peak timings do not occur at regular intervals is that there is a high possibility that the sound classified into the cluster is not the sound emitted by the rotary drive component.

The region identifier 222 collates the cycle of the sound for each cluster with the cycle for each component in the cycle table 214. The region identifier 222 searches for a component that emits a sound having a cycle close to the cycle of the sound for each cluster. For example, in a case where the cycle of the sound of the cluster 0 is close to the cycle of the sound of the component X, the region identifier 222 selects the component X as a sound generation source of the cluster 0 or a candidate thereof. According to an embodiment, the region identifier 222 may select a plurality of components as candidates for a sound generation source of a certain cluster. For example, in a case where the sound cycle of the cluster 0 is close to the sound cycles of the components X and Y, the components X and Y can be selected as candidates for the generation source of the sound (abnormal noise) of the cluster 0.

As an example, the region identifier 222 can determine the component p as an abnormal noise candidate by an equation of [Math. 1]. According to an embodiment, the region identifier 222 can calculate the equation [Math. 1] while excluding clusters having a cycle greater or smaller by a certain value or more. This is because there is a high possibility that sound having a cycle of a certain value or greater, or a certain value or less is not a sound emitted by the drive component.

$$\begin{matrix}[ Math . 1 ] & \\ p = arg {min}_{j ∈ P} ( abs ( {T}_{i} - {T}_{j} ) ) & 101\end{matrix}$$

$${T}_{i} = Calculated cycle \qquad 102$$

$$P = List of cycles of searched components \qquad 103$$

$${T}_{j} = Cycle of component j \qquad 104$$

FIG. 12 is a diagram illustrating an example of a first window 1200 displayed on the display 224. According to an embodiment, the first window 1200 is displayed on the screen of the diagnosis device 120. According to another embodiment, the display 224 transmits the data of the first window 1200 to another device (smartphone 226, PC 228, etc.). The other device displays the data of the first window 1200 on the screen. The first window 1200 is generated by the UI program 218.

The first window 1200 is a screen before execution of the sound diagnosis. The first window 1200 includes a parameter setting necessary for analysis, execution buttons for recording and analysis, and the like. The user (service engineer or the like) can select a sound file (collected sound data) on the first window 1200 and press the Analysis button to acquire an analysis result. When the Analysis button is pressed, the first window 1200 transitions to the second window 1300.

FIG. 13 is a diagram illustrating an example of a second window 1300 displayed on the display 224. According to an embodiment, the second window 1300 is displayed on the screen of the diagnosis device 120. According to another embodiment, the display 224 transmits the data of the second window 1300 to another device (smartphone 226, PC 228, etc.). The other device displays the data of the second window 1300 on the screen. The second window 1300 is generated by the UI program 218.

The second window 1300 is a screen showing an analysis result of the sound file (collected sound data). The second window 1300 displays a cycle of each cluster and a component name that emits a sound having a cycle close to the cycle of the sound of each cluster. The second window 1300 may display a plurality of component names when there is a plurality of components that emit a sound having a cycle close to the cycle of the sound of each cluster.

FIG. 14 is a diagram illustrating the rest of the second window 1300 displayed on the display 224. The diagnosis device 120 or another device can continuously display the window of FIG. 13 and the window of FIG. 14 by receiving a scroll operation from the user. According to an embodiment, the window of FIG. 13 and the window of FIG. 14 may be displayed separately. In this case, the diagnosis device 120 or another device can repeat the window of FIG. 13 and the window of FIG. 14 by receiving a window or tab switching operation from the user. The second window 1300 may include arbitrary information such as a spectrogram in addition to the classification result of the cluster and the component name that is a candidate for the generation source of the abnormal noise.

### E. EXAMPLE OF NOISE REMOVAL AND INFERENCE OF FAILED COMPONENT

Next, a method of removing noise from sound in each cluster and a procedure of inferring a failed component will be described in detail with reference to FIGS. 15 to 19.

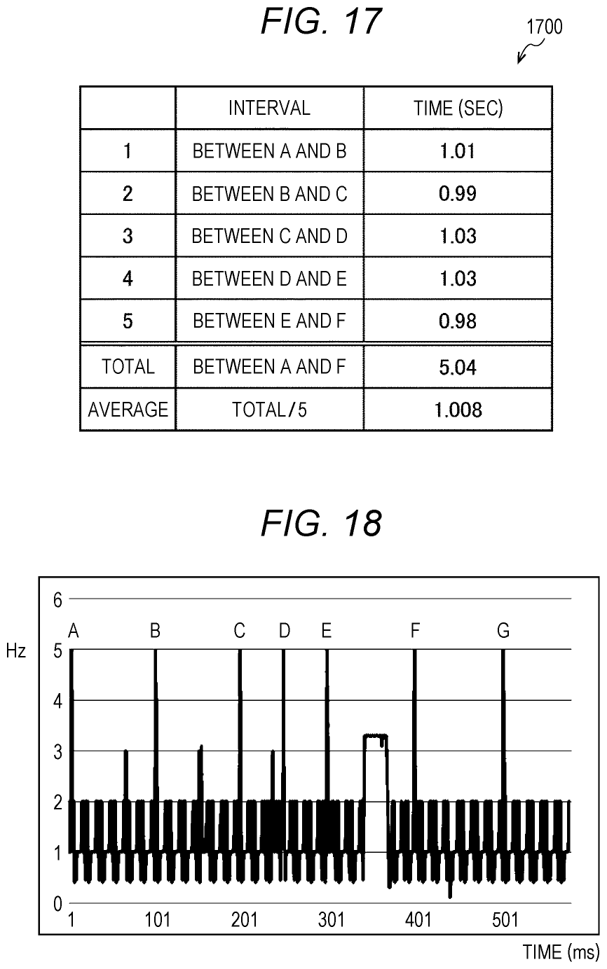

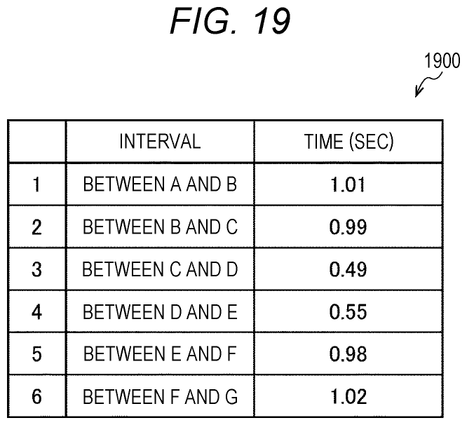

FIG. 15 is a diagram illustrating an example of the cycle table 214. The cycle table 214 includes cycle information for each driving component included in the device 130. According to an embodiment, the cycle table 214 may be represented as a table of a relational database. Furthermore, the cycle table 214 may be expressed in any other data format such as JavaScript (registered trademark) Object Notation (JSON). The region identifier 222 collates the cycle table 214 with the calculation result of the generation cycle of the clustered peak timings as illustrated in FIGS. 17 and 19.

FIG. 16 is a diagram illustrating a first example of a set of clustered peak timings. In FIG. 16, A, B, C, D, E, and F are peak timings classified into the same cluster. The cycle calculator 210 calculates a cycle between the peak timings A, B, C, D, E, and F. By this calculation, a calculation result 1700 illustrated in FIG. 17 is obtained.

FIG. 17 is a diagram illustrating an example of a calculation result 1700 of an occurrence cycle of the clustered peak timings. The cycle calculator 210 calculates an interval between adjacent peak timings. For example, the cycle calculator 210 calculates an interval “1.01 seconds” between the peak timings A and B. Next, the cycle calculator 210 calculates an average value “1.008 seconds” of the calculated intervals between adjacent peak timings.

The region identifier 222 compares the average value “1.008 seconds” of the intervals between the peak timings in the cluster with the cycles of the sounds of the components in the cycle table 214. It is unlikely that the average value of the intervals between the peak timings in the cluster completely matches the cycle of the sound of each component in the cycle table 214. Therefore, according to an embodiment, the region identifier 222 selects a component that emits a sound having a cycle closest to the average value of the intervals of the peak timings in the cluster. In the examples of FIGS. 12 and 17, the region identifier 222 selects the “fuser gear 1” that emits a sound having a cycle “1.12” closest to the average value “1.008 seconds”.

According to another embodiment, the region identifier 222 may select at least one component that emit a sound in a cycle closest to the average value of the intervals of the peak timings in the cluster by at least a certain amount. In the examples of FIGS. 12 and 17, the region identifier 222 selects the “fuser gear 1” that emits a sound with a cycle “1.12” close to the average value “1.008 seconds”. In addition, the region identifier 222 selects the “fuser belt” that emits a sound with a cycle “1.02” close to the average value “1.008 seconds”.

FIG. 18 is a diagram illustrating a second example of a set of clustered peak timings. With reference to FIG. 18, a description will be given of a procedure for removing noise when an unrelated sound (noise) is included in a cluster of a sound of a certain component. In FIG. 18, A, B, C, D, E, F, and G are peak timings classified into the same cluster. In the example of FIG. 18, D is a noise component. The cycle calculator 210 calculates cycles between the peak timings A, B, C, D, E, F, and G. By this calculation, a calculation result 1900 illustrated in FIG. 19 is obtained.

FIG. 19 is a diagram illustrating an example of a calculation result 1900 of an occurrence cycle of clustered peak timings. The cycle calculator 210 calculates an interval between adjacent peak timings.

According to the calculation result 1900, the intervals of the sections C to D and the intervals of the sections D to E are clearly different from the intervals of the other sections. In this manner, the cycle calculator 210 can remove, as a noise component, a section that deviates from values of other sections by a certain amount or more. Alternatively, the cycle calculator 210 can remove, as a noise component, a section that deviates from an average value of other sections by a certain amount or more. At that time, the cycle calculator 210 may ignore D and adopt the sections C to E as the valid data. Alternatively, the cycle calculator 210 may consider the section C to E including D as invalid data.

The cycle calculator 210 may obtain the accuracy of the detection time from the cycle table 214. For example, according to the cycle table 214, the difference between the fuser belt and the fuser gear is about 10%. Therefore, the cycle calculator 210 sets 10% as an exclusion threshold. The cycle calculator 210 can remove, as noise, a peak timing included in a section deviated by a threshold (for example, 10%) or more from an average value of intervals of each section.

According to an embodiment, the threshold value may be defined by a user or may be a fixed value. In addition, a cycle larger than “1.12 seconds” in the cycle table 214 does not exist as a cycle of the sound emitted by the component. A cycle smaller than “0.42 seconds” in the cycle table 214 does not exist as a cycle of the sound emitted by the component. Therefore, the cycle calculator 210 can remove, as noise, such a sound (peak sound) of a cycle that the component does not emit. That is, the sound diagnosis system 100 can exclude a sound having a frequency generated from components other than a monitoring target from the extraction target, when extracting the plurality of peak timings from the total sound pressure. In other words, the sound diagnosis system 100 can exclude a sound having a frequency that the component to be monitored will not emit from the extraction target.

As an example, the region identifier 222 determines whether the interval between the peak timings in a certain cluster is a certain value or greater, or a certain value or less. In a case where the interval between the peak timings is the certain value or greater, or the certain value or less, the region identifier 222 determines that the sound included in a certain cluster is not the sound emitted by the rotating component. The region identifier 222 excludes a cluster in which the interval between the peak timings is the certain value or greater, or the certain value or less from the component identification processing.

As another example, the region identifier 222 determines whether the variation in the interval between the peak timings in a certain cluster is a certain value or greater. In a case where the variation in the interval between the peak timings in a certain cluster is the certain value or greater, the region identifier 222 determines that the sound included in the certain cluster is not the sound emitted by the rotary component. The region identifier 222 excludes a cluster in which the variation in the interval of each peak timing is the certain value or greater from the component identification processing.

Next, the cycle calculator 210 calculates an average value of intervals between adjacent peak timings calculated in a state where the noise component D has been removed. Since the procedure of identifying the component of the generation source of the abnormal noise is similar to the procedure described with reference to FIG. 17, the description of the procedure will not be repeated.

In the present specification, the configuration in which the diagnosis device 120 includes the microphone 202 has been described, but the application example of the technique of the present disclosure is not limited thereto. According to an embodiment, the device 130 to be diagnosed may comprise a microphone. In this case, the device 130 transmits the sound data to the diagnosis device 120 or the server 110.

As described above, the sound diagnosis system 100 according to the technique of the present disclosure calculates the sum of frequency components (total sound pressure) at each timing in the spectrogram. Furthermore, the sound diagnosis system 100 can obtain a relative height (relative sound pressure) between peaks and classify the peaks on the basis of the relative height. As a result, components having different frequency components but close relative values of peaks are likely to be classified into the same cluster.

According to an embodiment, it is possible to specify the source of the abnormal noise even in an environment where a sound diagnosis device picks up sounds of a plurality of sound sources.

Although embodiments of the present invention have been described and illustrated in detail, the disclosed embodiments are made for purposes of illustration and example only and not limitation. The scope of the present invention is not defined by the above description, but should be interpreted by terms of the appended claims, and is intended to include all modifications within the meaning and scope equivalent to the claims. In addition, the disclosed contents described in the exemplary embodiment and the modifications are intended to be implemented alone or in combination as far as it is possible.

What is claimed is:

1. A sound diagnosis system comprising: a sound collector acquiring a sound emitted by a device;
a total sound pressure calculator that analyzes a sampling result of the sound and calculates a total sound pressure of a sound of each frequency included in each timing of the sampling result;
a peak detector that detects a plurality of peak timings from the total sound pressure;
a peak classifier that clusters the plurality of peak timings;
a cycle calculator that calculates a cycle of a sound included in each cluster based on the frequency and/or each total sound pressure;
a region identifier that identifies at least one component that emits a sound having a cycle close to any of cycles of sounds included in each cluster; and
a display that displays the at least one identified component.

2. The sound diagnosis system according to claim 1, wherein calculating the total sound pressure of the sound of each frequency included in each timing of the sampling result comprises calculating a sum or an average value of the sound pressures of the respective frequencies at respective timings.

3. The sound diagnosis system according to claim 1, wherein the total sound pressure calculator adjusts an addition value of sounds of the respective frequencies according to a generation frequency of the sound of the respective frequencies.

4. The sound diagnosis system according to claim 1, wherein extracting the plurality of peak timings from the total sound pressure comprises excluding a sound having a frequency generated from components other than a monitoring target from the extraction target.

5. The sound diagnosis system according to claim 1, wherein extracting the plurality of peak timings from the total sound pressure comprises extracting each of the peak timings based on a difference between the total sound pressure obtained by calculation at a certain timing among the timings and the total sound pressure obtained by calculation before and after the certain timing.

6. The sound diagnosis system according to claim 5, wherein the peak detector sets the certain timing as the peak timing when the difference is a predetermined threshold or greater.

7. The sound diagnosis system according to claim 1, wherein the peak detector stops detection of the peak timing for a certain period after detection of the peak timing.

8. The sound diagnosis system according to claim 1, wherein the peak classifier allocates each of the plurality of peak timings to one of the clusters by clustering using machine learning.

9. The sound diagnosis system according to claim 8, wherein the peak classifier automatically determines the number of clusters.

10. The sound diagnosis system according to claim 8, wherein the cycle calculator calculates a cycle for each of the clusters based on an interval between the adjacent peak timings in the same cluster.

11. The sound diagnosis system according to claim 10, wherein the cycle calculator calculates a cycle except for the peak timing inferred to be erroneously detected or erroneously classified.

12. The sound diagnosis system according to claim 1, wherein the region identifier determines that a sound included in a certain cluster is not a sound generated from a rotating component based on a fact that an interval between the peak timings in the certain cluster is a certain value or greater, or a certain value or less, and excludes the certain cluster from component identification processing.

13. The sound diagnosis system according to claim 1, wherein the region identifier determines that a sound included in a certain cluster is not a sound generated from a rotating component based on a fact that variation in an interval between the peak timings in the certain cluster is a certain value or greater, and excludes the certain cluster from component identification processing.

14. The sound diagnosis system according to claim 1, wherein the device is an image forming device including a plurality of drive sources.

15. The sound diagnosis system according to claim 14, wherein the drive source drives at least one of a fuser belt, a paper delivery roller, a paper feeding roller, and a fuser gear.

16. A sound diagnosis method comprising: acquiring a sound emitted by a device;
analyzing a sampling result of the sound and calculating a total sound pressure of a sound of each frequency included in each timing of the sampling result;
extracting a plurality of peak timings from the total sound pressure;
clustering the plurality of peak timings;
identifying a cycle of a sound included in each cluster based on the frequency and/or each total sound pressure;
identifying at least one component that emits a sound having a cycle close to any of cycles of sounds included in each cluster; and
displaying the at least one identified component.

17. A non-transitory recording medium storing a computer readable sound diagnosis program causing a computer to execute: acquiring a sound emitted by a device;
analyzing a sampling result of the sound and calculating a total sound pressure of a sound of each frequency included in each timing of the sampling result;
extracting a plurality of peak timings from the total sound pressure;
clustering the plurality of peak timings;
identifying a cycle of a sound included in each cluster based on the frequency and/or each total sound pressure;
identifying at least one component that emits a sound having a cycle close to any of cycles of sounds included in each cluster; and
displaying the at least one identified component.
